(19) United States
(12) Patent Application Publication
(10) Pub. No.: US 2002/0080224 A1
(43) Pub. Date: Jun. 27, 2002

(54) Apparatus for making visible recordings on a record carrier with the aid of a thermal transfer foil

(76) Inventor: Eduard Forster, Vienna (AT)

Correspondence Address: Michael E. Marion, c/o PHILIPS ELECTRONICS CORPORATION NORTH, AMERICAN CORPORATION,, 580 White Plains Road, Tarrytown, NY, 10591, US

(21) Appl. No.: 09/968,139

(22) Filed: Oct. 1, 2001

(30) Foreign Application Priority Data
Oct. 5, 2000 (EP) 00890301.5

(51) Int. Cl. B41J 35/24; B41J 35/04

(52) U.S. Cl. 347/217

(57) ABSTRACT

An apparatus (1) for making visible recordings on a record carrier (10) with the aid of a thermal transfer foil has foil path influencing means (41) which are arranged to cooperate with the thermal transfer foil and with the aid of which a perfect path of the thermal transfer foil can be obtained in the area of a thermal print head (13), in which the foil path influencing means (41) include a foil element (42) which extends across the full width of the thermal transfer foil and which has a mounting portion (43) and a portion (44) which projects from the mounting portion (43) and is pivotable with respect to the mounting portion (43), which portion (44) is always held in contact with the thermal transfer foil under the influence of the elasticity of the foil element (42).

The invention relates to an apparatus for recording visible recordings on a record carrier with the aid of a thermal transfer foil, which apparatus has drive means for driving the thermal transfer foil and a thermal print head for heating the thermal transfer foil in a point-by-point fashion, and pressure means with the aid of which the thermal print head and the record carrier can be pressed together with the thermal transfer foil interposed, and foil-path influencing means for influencing the path of the thermal transfer foil.

An apparatus as outlined in the opening paragraph is known, for example, from the patent document EP 0 982 140 A2. In the known apparatus the foil path influencing means form part of a print head unit, in such a manner that, viewed in the feed direction of the thermal transfer foil, a rear part of a head frame of the print head unit is constructed as a friction element, by means of which friction element different friction conditions are obtained in a direction transverse to the feed path. In the construction known from the patent document EP 0 982 140 A2 the friction conditions are realized in such a manner that a force which acts upon the thermal transfer foil in the area of the edge portions of the thermal transfer foil is greater than in the central area of the thermal transfer foil. In order to realize the construction known from the patent document EP 0 982 140 A2 requires a comparatively great expense. Moreover, the foil path influencing means are arranged in the feed path for the thermal transfer foil behind the thermal print head viewed in the feed direction of the thermal transfer foil, which appears to be a problem in practice because, as a result of this, a faultless recording on a record carrier by means of the thermal transfer foil fed from a supply mandrel to the thermal print head is not assured in all cases.

It is an object of the invention to preclude the aforementioned problems and to provide an improved apparatus.

In order to achieve this object characteristic features in accordance with the invention are provided in an apparatus in accordance with the invention, in such a manner that an apparatus in accordance with the invention can be characterized in the manner defined hereinafter, namely:

An apparatus for making visible recordings on a record carrier with the aid of a thermal transfer foil, which record carrier and which thermal transfer foil can be loaded into the apparatus and which apparatus has the means defined hereinafter, i.e. drive means, which serve to and are adapted to drive the thermal transfer foil and with the aid of which the thermal transfer foil can be fed from a supply mandrel to a take-up mandrel along a feed path and past a thermal print head, and the thermal print head, which has a substantially elongate shape and whose longitudinal dimension extends transversely to the feed path and with the aid of which a point-by-point heating of the thermal transfer foil can be realized, and pressure means, with the aid of the thermal print head and the record carrier can be pressed onto one another with the thermal transfer foil interposed, in order to transfer a dye carried by the thermal transfer foil to the record carrier in a point-by-point fashion by the point-by-point heating of the thermal transfer foil, and foil path influencing means, which are arranged to cooperate with the thermal transfer foil and which are adapted to influence the path of the thermal transfer foil and with the aid of which in the area of the thermal print head the thermal transfer foil can be given a path which guarantees that optimum visible recordings are made on a record carrier, in which the foil path influencing means have a foil element of a plastic, which foil element has a substantially elongate shape and of which foil element the longitudinal dimension extends transversely to the feed path and corresponds substantially to the width of the thermal transfer foil, and in which the foil element is arranged in the feed path before thermal print head, and in which the foil element has a first portion which extends transversely to the feed path and a second portion which extends transversely to the feed path, and in which the first portion is secured to an apparatus part which serves for holding the foil element, and in which the second portion is pivotable with respect to the first portion and is always held in contact with the thermal transfer foil under the influence of the elasticity of the foil element.

Owing to the provision of the measures in accordance with the invention it is achieved in a surprisingly simple manner that with the aid of the foil element provided as foil path influencing means an elongation compensation is obtained for the thermal transfer foil, which elongation compensation provides compensation for any irregular thermal transfer foil elongations caused by the point-by-point heating of the thermal transfer foil, which always guarantees that no wrinkling occurs in the thermal transfer foil in the part of said foil which is fed to the thermal print head. This guarantees that the thermal transfer foil is always fed to the thermal print head in a perfectly smooth form, thereby always enabling perfect and faultless visible recordings to be made on a record carrier.

In an apparatus in accordance with the invention the longitudinal dimension of the foil element may be exactly equal to or slightly smaller than the width of the thermal transfer foil. However, it has proved to be particularly advantageous when the longitudinal dimension of the foil element is greater than the width of the thermal transfer foil because wrinkling in the thermal transfer foil as a result of the point-by-point heating of the thermal transfer foil is thus precluded in a particularly reliable manner.

In an apparatus in accordance with the invention the second portion of the foil element may project from the first portion towards the thermal transfer head. However, it has proved to be particularly advantageous when the second portion of the foil element projects from the first portion towards the supply mandrel. This is also advantageous in view of an elongation-free and wrinkle-free feed of the thermal transfer foil to the thermal print head.

For the material of which the foil element is made different plastic foils may be used. However, it has proved to be particularly advantageous when the foil element consists of a polyvinyl chloride material. The use of such a material in connection with elongation compensation and, consequently, a prevention of wrinkling in a thermal transfer foil has proved to be particularly advantageous, as was apparent from a series of tests.

The above-mentioned as well as further aspects of the invention will become apparent from the embodiment described hereinafter by way of example and will be elucidated with reference to this example.

The invention will now be described in more detail with reference to the drawings, which show an embodiment given by way of example but to which the invention is not limited.

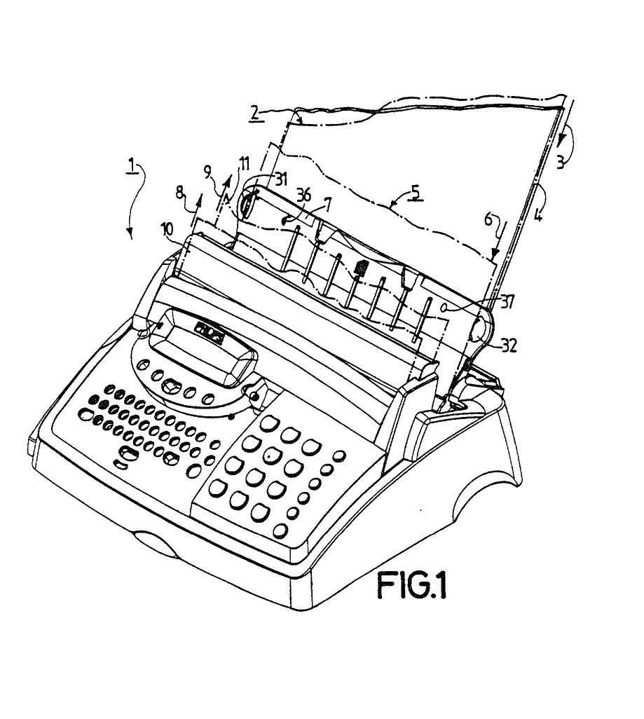

FIG. 1 is an oblique plan view of an apparatus in accordance with the invention in accordance with an embodiment of the invention, a scanning device of the apparatus being removed from the apparatus and, as a consequence, not being shown in FIG. 1.

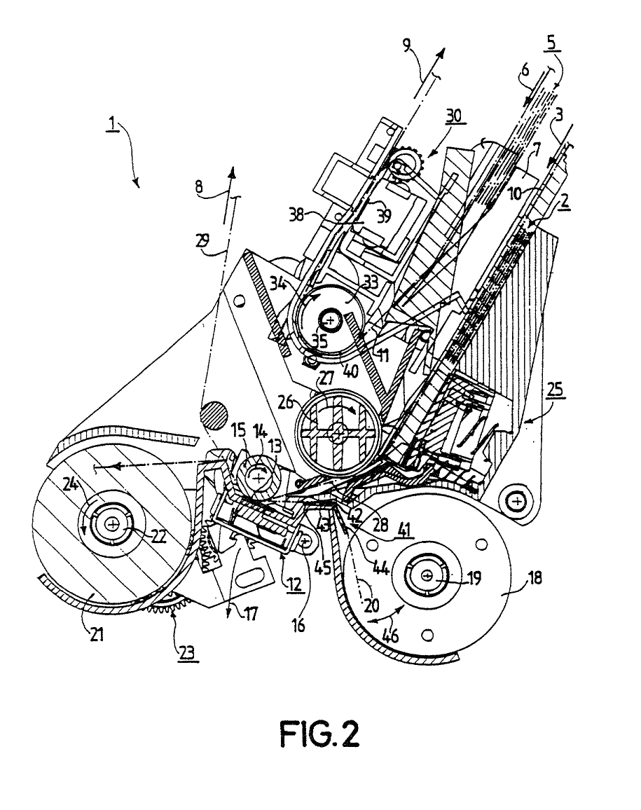

FIG. 2 is a partly diagrammatic cross-sectional view which shows a relevant part of the apparatus shown in FIG. 1, which part of the apparatus includes foil-path influencing means.

FIG. 1 shows an apparatus 1 in accordance with an embodiment of the invention. In the present case, the apparatus 1 is a facsimile apparatus, hereinafter briefly referred to as the apparatus 1.

A first stack 2 of record carriers to be printed can be loaded into the apparatus 1 in a direction indicated by an arrow 3, which stack 2 is shown in dash-dot lines in FIGS. 1 and 2. In its loaded condition the stack 2 lies on a supporting plate 4 of the apparatus 1. Moreover, a second stack 5 of record carriers to be scanned can be loaded into the apparatus 1 in a direction indicated by an arrow 6. The second stack 5 is also shown in dash-dot lines. In its loaded condition the stack 5 lies against a guide plate 7 of the apparatus 1. The guide plate 7 has two guide projections 31 and 32, by means of which the record carriers to be scanned from the second stack 5 are guided laterally. The two guide projections 31 and 32 each have a guide surface, the two guide surfaces facing one another and being spaced at a distance from one another, which distance corresponds to the width of a record carrier 11 to be printed. In the present case, this distance corresponds to the width of an A4 size sheet of paper. In addition, the guide plate 7 has two further guide projections 36 and 37 having a shape which essentially corresponds to that of the two guide projections 31 and 32, the distance between the guide surfaces of the two further guide projections 36 and 37 in the present case corresponding to the width of an A5 size sheet of paper.

The currently uppermost record carrier to be printed can be withdrawn from the stack 2 of record carriers to be printed and can subsequently be fed to a printing roller and thereupon out of the apparatus 1 in a direction indicated by an arrow 8, as is shown in dashdot lines in FIG. 1. Likewise, the currently uppermost record carrier to be scanned can be withdrawn from the second stack 5 of record carriers to be scanned and can be fed to a scanning device of the apparatus 1, which scanning device is not shown in FIG. 1 and by means of which it is possible to scan the graphic content of the respective record carrier to be scanned, after which the record carrier just scanned can be fed out of the apparatus 1 in the direction indicated by an arrow 9, as is also shown in dash-dot lines in FIG. 1.

The other parts of the apparatus 1 which are shown in FIG. 1, such as the housing, a telephone keypad, an alphanumeric keypad, a display device and the like, will not be described in any further detail.

The apparatus 1 is constructed to print a record carrier to be printed, which can be fed out of the apparatus 1 in the direction indicated by the arrow 8, i.e. to make visible recordings on a record carrier 10. The apparatus 1 is further constructed to scan a record carrier 11 to be scanned, which can be fed out of the apparatus 1 in the direction indicated by the arrow 9.

The apparatus 1 includes a printing device 12 having a print head 13. The print head 13 is a thermal print head which has a substantially elongate shape and is substantially strip-shaped, by means of which print head it is possible to print in a point-by-point fashion. This printing is effected on a record carrier 10 to be printed, i.e. a blank sheet. The record carrier 10 to be printed can be driven in steps with the aid of a printing roller 15 which is drivable in a direction indicated by an arrow 14 (i.e. clockwise). The printing roller 15 cooperates with the print head 13. The printing roller 15 is mounted in the apparatus 1 so as to be rotatable, but apart from that it is stationary. The printing device 12 is held against the printing roller 9 with the aid of spring means, not described and not shown, the print head 13 thus being urged against the printing roller 15 under spring load. The printing device 12 including its print head 13 is pivotable about an axis 16 and is movable away from the printing roller 15 in a direction indicated by an arrow 17. The movement of the printing device 12 away from the printing roller 15 is effected with the aid of an actuating device which is not shown in FIG. 1 and which can be driven by means of the printing roller 15. The printing roller 15 and the spring means, not shown, form pressure means with the aid of which the print head 13 and the record carrier 10 can be pressed onto one another with an interposed thermal transfer foil, which will subsequently be described in more detail.

In the apparatus 1 a thermal-transfer printing process can be performed by means of the print head 13. In this thermal-transfer printing process a thermal-transfer foil is heated in a point-by-point fashion with the aid of the print head 13, as a result of which a wax-like dye carried by the thermal transfer foil is transferred in a point-by-point fashion to the record carrier 10 to be printed. Said thermal transfer foil is wound onto a first reel 18, the first reel 18 with the supply of thermal transfer foil being carried by a supply mandrel 19. From the first reel 18 the thermal transfer foil is led to a second reel 21 along a feed path 20 shown as a dash-dot line, which second reel is carried by a take-up mandrel 22. The take-up mandrel 22 can be driven by the printing roller 15 in a direction indicated by an arrow 24 via a transmission gear 23, which is shown partly in FIG. 2.

In order to print a record carrier 10 to be printed such a record carrier 10 to be printed should be withdrawn from a blank-sheet feeder 25 which contains a stack 2 of such record carriers to be printed, i.e. it should be separated from the stack. For this purpose, the apparatus 1 has a blank-sheet withdrawal roller 26, which is rotationally drivable in a direction indicated by an arrow 27, i.e. clockwise. The currently uppermost record carrier to be printed can be withdrawn from the first stack 2 in the blank-sheet feeder 25 with the aid of the blank-sheet withdrawal roller 26 and be fed into the area between the print head 12 and the printing roller 15. As soon as a record carrier 10 to be printed has reached the printing roller 15, the record carrier 10 to be printed is fed further by means of the printing roller 15, the blank-sheet withdrawal roller 26 then being out of driving engagement, as is already known per se from such apparatus since long. A record carrier 10 to be printed is fed between the blank-sheet feeder 25 and the printing roller 15 along a feed path 28 shown as a dash-dot line in FIG. 2. After the record carrier 10 to be printed has been printed the printed record carrier 10 is fed along a feed path 29, which is likewise shown as a dash-dot line in FIG. 2, and is then fed out of the apparatus 1 in the direction indicated by the arrow 8.

The apparatus 1 further includes a scanning device 30, by means of which a record carrier 11 to be scanned, i.e. an original document, can be scanned in order to convert the graphic information on the record carrier 11 to be scanned, for example alphanumeric characters, into digital signals. In FIG. 2 the scanning device 30 is shown only diagrammatically.

The scanning device 30 is accommodated in a separate housing. In this way, it is achieved that the scanning device 30 forms a separate unit and can consequently be separated readily and simply from the apparatus 1 so as to be removed from the apparatus 1. In a first mode of operation, in which the scanning device 30 is connected to the apparatus 1, as is illustrated in FIG. 2, as well as in a second mode of operation, in which it is separated from the apparatus 1, as is not shown in the Figures, said scanning device can scan a record carrier 11 to be scanned. In the first mode of operation as shown in FIG. 2, the record carrier 11 to be scanned can be fed past the scanning device 30, which is immobile in the apparatus 1, with the aid of drive means to be described briefly hereinafter. In the second mode of operation the scanning device 30 can be moved by hand over the stationary record carrier 11 to be scanned.

In order to enable scanning of a record carrier 11 to be scanned in the first mode of operation illustrated in FIG. 2, such a record carrier 11 to be scanned must be withdrawn from the second stack of record carriers to be scanned. For this purpose, the apparatus 1 has an original-document withdrawal roller 33, which is rotationally drivable in a direction indicated by an arrow 34 (i.e. clockwise). The original-document withdrawal roller 33 is mounted so as to be rotatable with the aid of a spindle 35. The original-document withdrawal roller 33 can be driven in steps in the direction indicated by the arrow 34, namely with the aid of apparatus-mounted drive means, which are neither shown nor described any further. The original-document withdrawal roller 33 provided as withdrawal means is accommodated in the scanning device 30, which withdrawal roller serves for withdrawing a record carrier 11 to be scanned from the second stack 5 of record carriers to be scanned, the leading edges of the record carriers to be scanned of this stack 5 being situated in the area of the withdrawal means, i.e. in the area of the original-document withdrawal roller 33, as can be seen in FIG. 2.

In order to enable the actual scanning of a record carrier 11 to be scanned after withdrawal of this record carrier 11 to be scanned, the withdrawn record carrier 11 to be scanned should be driven stepwise in the apparatus 1, the withdrawn record carrier 11 to be scanned being fed to an elongate scanning unit 38 during this driving process. The scanning unit 38 includes a photoelectrically operating scanning strip 39, which is held in close contact with a record carrier 11 to be scanned, namely in that spring means, not shown, urge the scanning unit 38 towards the record carrier 11 to be scanned.

For driving a withdrawn record carrier 11 to be scanned the apparatus 1 has two original-document drive rollers 40, of which only one original-document drive roller 40 is shown in FIG. 2 and which serve as drive means for driving a withdrawn record carrier 11 to be scanned in the apparatus 1, in order to feed the withdrawn record carrier 11 to be scanned to the scanning unit 38 and move it past the scanning device 30, i.e. past the scanning unit 38. The two original-document drive rollers 40 provided as drive means are also accommodated in the scanning device 30. Like the original-document withdrawal roller 33, the two original-document drive rollers 40 and 41 provided as drive means are also rotatably mounted with the aid of the spindle 35 and are coaxial with the original-document withdrawal roller 33. The two original-document drive rollers 40 consist of a material having a comparatively high coefficient of friction and have a diameter which is slightly greater than the diameter of the original-document withdrawal roller 33. Further details on the construction of the spindle 35 and the original-document withdrawal roller 33 as well as the two original-document drive rollers 40 and 41 can be found in, for example, the patent document U.S. Pat. No. 5,820,121 A.

As regards the drive means for the printing roller 15, the take-up mandrel 22, the blank-sheet withdrawal roller 26 and the original-document drive rollers 40 and 41, as well as the original-document withdrawal roller 33, reference is made to the European priority patent application of Dec. 23, 1999 having the application No. 99 890 402.3, whose subject matter is incorporated herein by reference.

As already stated hereinbefore, the thermal transfer foil is heated in a point-by-point fashion with the aid of the print head 13 in the thermal transfer printing method that can be carried out with the apparatus 1, in order to transfer a dye carried by the thermal transfer foil to the record carrier 10 to be printed. The point-by-point heating of the thermal transfer foil, which is guided and fed along the feed path 20 from the reel 18 wound on the supply mandrel 19 to the second reel 21 wound on the take-up mandrel 22, leads to irregular elongations in the thermal transfer foil, which irregular elongations may produce an effect in the thermal transfer foil opposed to the feed direction of thermal transfer foil, which may result in wrinkling in the part of the thermal transfer foil fed from first reel 18 to the print head 13, which leads to an unsatisfactory printing quality because such wrinkles formed in the thermal transfer foil are reproduced in an undesirable manner on a record carrier 10 to be printed, namely as annoying lines.

In order to preclude such undesired effects in the apparatus 1 the apparatus 1 includes foil path influencing means 41. The foil path influencing means 41 are arranged to cooperate with the thermal transfer foil and are adapted to influence the path of the thermal transfer foil. The foil path influencing means make it possible to obtain a path of the thermal transfer foil, which path guarantees an optimum recording of visible recordings on a record carrier 10 to be printed. In the apparatus 1 the foil path influencing means 41 comprise a foil element 42. The foil element 42 has a substantially elongate shape, the longitudinal dimension of the foil element 42 extending transversely to the feed path 20 of the thermal transfer foil. In the present case, the longitudinal dimension of the foil element 42 is selected so as to be greater than the width of the thermal transfer foil. The foil element 42 is arranged in the feed path 20, before the print head 20.

The foil element 42 has a first portion 43 which extends transversely to the feed path 20, and a second portion 44 which extends transversely to the feed path 20. The first portion 43 serves to mount the foil element 42 and for this purpose it is secured to an apparatus part 45 provided in order to hold the foil element 42. The second portion 44, which is integral with the first portion 43, projects from the first portion 43 towards the supply mandrel 19 and, consequently, towards the first reel 18 and, as a result of the elastic deformability of the foil element 42, it is pivotable with respect to the first portion 43, namely as indicated by the double arrow 46 in FIG. 2. As a result of this pivotability of the second portion 44 with respect to the first portion 43 it is achieved that under the influence of the elasticity of the foil element 42 the second portion 44 is always applied to the thermal transfer foil, namely independently of the diameter of the first reel 18, i.e. both in the case of a large reel diameter and in the case of a small reel diameter. The application of the second portion 44 to the thermal transfer foil results in a bend in the path of the thermal transfer foil in the area of the free end of the second portion 44, as is shown for the feed path 20 of the thermal transfer foil.

As a result of the arrangement described above, it is achieved that the foil element 42 and, particularly, the second portion 44, is always in operative contact with the thermal transfer foil. The foil element 42 thus has an elongation-compensating effect on the thermal transfer foil, which effect compensates for irregular elongations of the thermal transfer foil caused by the point-by-point heating of the thermal transfer foil, as a result of which wrinkling in the part of the thermal transfer foil fed to the print head 13 is precluded and, consequently, the thermal transfer foil always enters into the area of the print head 13 in a perfectly smooth condition and therefore an adverse effect of the thermal transfer foil on the printing process is avoided.

It is to be noted that the foil element 42 consists of a polyvinyl chloride material. Tests have proved that this material is particularly advantageous for an effective elongation compensation in the thermal transfer foil. It is to be noted that other materials may also be used for a foil element provided as foil path influencing means.

1. An apparatus (1) for making visible recordings on a record carrier (10) with the aid of a thermal transfer foil, which record carrier and which thermal transfer foil can be loaded into the apparatus (1) and which apparatus (1) has the means defined hereinafter, i.e.:
drive means, which serve to and are adapted to drive the thermal transfer foil and with the aid of which the thermal transfer foil can be fed from a supply mandrel (19) to a take-up mandrel (22) along a feed path (20) and past a thermal print head (13), and
the thermal print head (13), which has a substantially elongate shape and whose longitudinal dimension extends transversely to the feed path and with the aid of which a point-by-point heating of the thermal transfer foil can be realized, and
pressure means, with the aid of the thermal print head (13) and the record carrier (10) can be pressed onto one another with the thermal transfer foil interposed, in order to transfer a dye carried by the thermal transfer foil to the record carrier in a point-by-point fashion by the point-by-point heating of the thermal transfer foil, and
foil path influencing means (41), which are arranged to cooperate with the thermal transfer foil and which are adapted to influence the path of the thermal transfer foil and with the aid of which in the area of the thermal print head (13) the thermal transfer foil can be given a path which guarantees that optimum visible recordings are made on a record carrier,
in which the foil path influencing means (41) have a foil element (42) of a plastic, which foil element (42) has a substantially elongate shape and of which foil element (42) the longitudinal dimension extends transversely to the feed path (20) and corresponds substantially to the width of the thermal transfer foil, and
in which the foil element (42) is arranged in the feed path before thermal print head (13), and
in which the foil element (42) has a first portion (43) which extends transversely to the feed path (20) and a second portion (44) which extends transversely to the feed path (20), and
in which the first portion (43) is secured to an apparatus part (45) which serves for holding the foil element (42), and
in which the second portion (44) is pivotable with respect to the first portion (43) and is always held in contact with the thermal transfer foil under the influence of the elasticity of the foil element (42).

2. An apparatus (1) as claimed in claim 1, in which the longitudinal dimensions of the foil element (42) is greater than the width of the thermal transfer foil.

3. An apparatus (1) as claimed in claim 1, in which the second portion (44) of the foil element (42) projects from the first portion (43) towards the supply mandrel (19).

4. An apparatus (1) as claimed in claim 1, in which the foil element (42) consists of a polyvinyl chloride material.
